(19) United States
(12) Patent Application Publication
(10) Pub. No.: US 2009/0142636 A1
(43) Pub. Date: Jun. 4, 2009

(54) Carbon Fiber Warming System for Fiber Composite Gas Storage Cylinders

(76) Inventor: Kiyoshi Handa, Takanezawa-cho (JP)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 11/947,813

(22) Filed: Nov. 30, 2007

(51) Int. Cl. H01M 8/04

(52) U.S. Cl. 429/26

(57) ABSTRACT

A heating system for a fiber composite high pressure gas storage tank for maintaining the temperature of the gas within the tank and the gas flow components associated with one or more boss at the tank ends above the lower design tolerance limit for the tank and flow control assembly, wherein the tank is formed from a polymeric binder having embedded therein longitudinally extending conductive and resistive fiber material strands, comprising an electric power source interconnected with the conductive and resistive tank wall whereby the fibers in the tank wall comprise a heater for warming the tank system such that the temperature of the components associated with the tank assembly does not drop below the lower tolerance temperature limit of the tank assembly.

### FIELD OF THE INVENTION

The present invention relates to a heating system for high pressure storage tanks for hydrogen and CNG gas fuel, or other gas, by compensating for thermal and mechanical stresses caused by a low temperature resulting from (1) gas decompression in the tank during driving as the gas is depleted from the tank and (2) environmental exposure of the tanks in low temperature climate conditions. The present invention heats the gas stored within the tank and ameliorates mechanical stresses to the tank and the component parts of the tank caused by the thermal conditions of the tank environment and thermal changes in gas temperature associated with the depletion of high pressure gas from the tanks.

### BACKGROUND OF THE INVENTION

Vehicles powered by compressed natural gas (CNGV) and hydrogen gas (FCV) typically include on board high pressure gas fuel tanks that may include gas absorbing materials within the tank interior. During driving, the gas inside the tanks becomes cold, caused by the tank pressure decreasing when gas is consumed by the vehicle power plant resulting in decompression of the tank. Gas absorbing materials used in the tank interior will absorb the intrinsic heat in the gas during the gas discharge from the tank during vehicle operation. In cold climates, the internal gas temperature in the tank can drop to −60° C. or below, a temperature that may be below the permissible operating temperature of 0-rings, or other rubber seals, or gas flow controls in the tank. An excessively low temperature in the tank may upset design tolerance limits for the seals and flow controls and cause the stored gas to leak as a result of temperature caused stresses in the tank system assembly. As an example, when the ambient temperature is −20° C., the reduction of internal tank temperature by an additional −40° C. due to gas decompression effects will result in an internal temperature in the gas tank of −60° C. Expansion and contraction of the tank and the component parts of the gas flow system associated with the tank may produce adverse mechanical stress effects. In the specification, reference to hydrogen fuel cell vehicles correlates with the use of the invention with CNGV's (compressed natural gas powered vehicles) and hydrogen powered fuel cell vehicles (FCV's) or internal combustion engine vehicles powered by either compressed natural gas (CNG) or hydrogen. Although hydrogen is typically referred to in the specification and examples, the term “hydrogen” is in most instances intended to be interchangeable with CNG and other fuel gases. Fuel gases are referred to as a “gas” or “high pressure gas.”

### OBJECTS OF THE INVENTION

It is an object of the present invention to provide a warming system for a carbon fiber composite tank utilizing the intrinsic electrical conductive characteristics of the tank to warm the inside of tank and the gas therein during driving conditions. It is a further object to reduce the risk of a fuel gas leak in cold climate driving conditions caused by excessively low tank and/or gas temperatures. As a result, tank durability is increased because overall system temperature differences are minimized.

The invention is described more fully in the following description of the preferred embodiment considered in view of the drawings in which:

### BRIEF DESCRIPTION OF THE SEVERAL VIEWS OF THE DRAWINGS

FIG. 1 is a cut away view showing a typical cylindrical high pressure gas storage tank formed from a carbon composite material wherein a carbon fiber strand material is impregnated within an epoxy or other resin binder. The tank shown includes a metal boss at each end and inlet and outlet gas flow components embedded within the boss at one end, and an interior volume.

FIG. 2 is a chart of gas and valve temperatures of the tank plotted against a time axis depicting relative temperatures of the gas within the tank and the metal boss elements during the vehicle conditions of driving and parking. The cooling of the metal components after driving is shown wherein valve temperatures are below the lower tolerance limit after driving.

FIG. 3 is a side view of a tank and warming system of the invention wherein an electric power source is interconnected with embedded electrodes connecting with the conductive fiber elements forming the tank wall to provide heating for the gas and tank.

FIG. 4 is a side view of a warming system of the invention wherein an electric power source is interconnected to the conductive metal bosses extending from opposite ends at either side of the tank.

FIG. 5 is a side view of a warming system of the invention wherein an electric power source is interconnected to intrinsically formed conductive fiber extensions leading from each of the opposite sides of the tank ends.

FIG. 6 is a side view of a warming system of the invention wherein electrodes are implanted within the tank wall at locations predetermined on the tank based on the conductivity properties of the composite material forming the tank. The electrodes are interconnected with an electric power source.

FIG. 7A is an enlarged cross section of tank wall segment 7A→ ←7A through the tank wall shown in FIG. 6. FIG. 7B shows enlarged cross sections of a tank wall segment showing an alignment of fibers. In each Figure, the fibers comprise a mixture of conductive filler and carbon fiber embedded in an epoxy material forming the composite.

FIG. 8A shows, in a side cross section detail, a tank including a conductive/resistive composite structure having an interior metal liner with an insulating layer sandwiched between the conductive composite tank structure and a metal liner in the tank. FIG. 8B is a cross section through section 8B → ← 8B of the metal lined tank wall of FIG. 8A.

FIG. 9 illustrates a temperature control system utilized in the invention with the heating system of FIG. 3 shown as an example.

### DETAILED DESCRIPTION OF THE INVENTION

In brief, the invention provides a warming system for high pressure gas storage tanks utilized on high pressure gas fueled vehicles including vehicles powered by compressed natural gas, CNG, and fuel cell and internal combustion engines powered by hydrogen gas. In many examples, such vehicles include gas fuel tanks that may include gas absorbing materials in the interior of the tank. During driving, the gas cools because a decrease in the tank pressure occurs. When a vehicle tank includes gas absorbing materials, the gas absorbing materials absorb heat during the gas discharge from the tank further contributing to the cooling effect. Environmentally, a typical ambient temperature is approximately 20° C. In cold climates, the internal gas temperature in a vehicle tank can drop to −60° C. or below, a temperature that may be below the permissible operating temperature range of O-ring and/or other rubber or polymer seals used in the tank and the port inlet and outlet metal part assemblies that control the inflow and outflow of gas to and from the storage tank. Below the acceptable temperature range, variances allowable for seals, valves, control devices, and the like, may be exceeded by thermally caused mechanical variations in the tank and associated assemblies. Leakage of the stored gas may result.

The invention provides a solution that can efficiently warm the storage tank utilizing intrinsic electrical conductivity characteristics of the fiber and binder materials utilized in the fabrication of the tank. In examples, the carbon fiber layer in the tank itself can be used as a heater to warm the gas tank itself. Because carbon fiber layer has an electrical conductivity, the fiber can be heated up when an electrical potential is applied to an appropriate resistive expanse of a tank section. In another example, the metal end ports of the tank can be used as electrical terminals applying the current to the conductive tank fiber. Intrinsic extensions fabricated from the tank material and interconnected with the conductive tank fiber can be used as electrical terminals. In other examples, electrical terminals can be installed in the tank wall, connecting with conductive fibers, allowing a connection to the electric warming current. In instances wherein the carbon fiber of the tank is excessively conductive, conductive filler is mixed into the resin (epoxy) forming the tank is effective to reduce the resistance. Usually the resin will have a very high electrical resistance. Similarly, variations in the proportional mixture of conductive fiber and the carbon fiber are effective to reduce the resistance. In instances where the tank includes a metal liner, the metal liner has much lower resistance than the carbon layer and will produce an electrical short. An electrical isolation layer between the tank carbon fiber and the metal liner will prevent an electrical short from occurring.

Using the invention, only a small change in tank design is required and higher heating efficiency will result compared with an external heater system because the tank itself is heated up directly. Fiber composite high pressure storage tanks are formed from extending fiber strands, filler, and other materials embedded in a resin foundation. The invention provides a heating system for a fiber composite high pressure gas storage tank whereby the temperature of the gas within the tank and the gas flow components associated with the tank gas flow control system at one or more boss assembly at the tank ends are maintained above the lower temperature design tolerance limit for the tank and boss assembly. In the invention, the tank wall is formed from a polymeric binder having embedded therein longitudinally extending electrically conductive and resistive fiber material strands and an electric power source is interconnected with the conductive and resistive fibers forming the tank wall.

The electrically conductive and resistive fiber material strands in the tank intrinsically heat the tank and boss assembly system upon the application of an electric current. In examples, 1) electrodes are embedded in the composite fiber composition of the tank wall to define an electrically resistive path for current flow within the conductive fiber materials of the tank wall; 2) conductive metal bosses at either end of the tank are connected to an electrical power source providing a flow of warming current to the conductive shell; 3) an electric power source is interconnected to electrically conductive fiber extension elements intrinsically formed in the tank shell and lead from the conductive composite tank shell at each of the opposite sides of the tank ends to an interconnection with an electrical power source. When a metal boss is at either or both ends of the tank and a tank wall has an interior metal liner; an insulating layer sandwiched between the conductive fiber composite tank shell structure and the metal liner is provided wherein the insulating layer isolates the conductive wall of the tank from the electrically conductive fiber wall and the one or more metal boss from the flow of electric current.

A temperature control system utilizing temperature sensors may be utilized in embodiments of the invention to provide temperature stabilization. Measurement data is input into the control system for one or more of valve temperature, tank wall temperature, gas temperature and ambient temperature. The control temperature maintained by the system, as determined by the flow of electric current into the fiber components of the tank is such that the gas temperature and the temperature of the metal components associated with the tank does not drop below the lower tolerance temperature limit of the tank and the components associated with the tank gas flow control system at the one or more boss at the tank ends.

Electrically conductive materials forming the tank wall include a filler comprised of a metal powder composition; the powder composition may include one or more of aluminum, copper, nickel, silver, stainless steel, and titanium (Al, Cu, Ni, Ag, SUS, and Ti) powders, a carbon black powder, ceramic powder, and plastic powder coated with an electrically conductive metal. Preferred electrically conductive materials used in forming the tank wall include a filler that is usually a powder composition characterized by an average particle size diameter ranging from about approximately 0.1×10̂−6 m to about approximately 500×10̂−6 m. Electrically conductive carbon nano tubes may be embedded in the tank wall composition. Other electrically conductive fiber materials used in forming the tank wall include metal wires and carbon, glass, and plastic fibers coated with metal.

The resistive/conductive properties of the tank wall to which the electric current is applied range from 0.1 ohm to 100 ohm. The electric power source is interconnected with electrodes associated with the tank wall to form an electrically active circuit for current flow and the warming power input into the system. Warming power, P-warming [W], is determined by the tank and gas flow assembly tolerance temperature during the vehicle operation, wherein Warming Power Current (I) is determined by the formula: I-tank=(P-warming/R-tank)̂0.5; and Warming Power Voltage (E) is determined by the formula: EI-tank=I-tank×R-tank. The electric power source interconnected with the tank wall may be isolated from other electric lines in the vehicle and in such an instance, a DC/DC converter or DC/AC inverter comprises the tank warming power source.

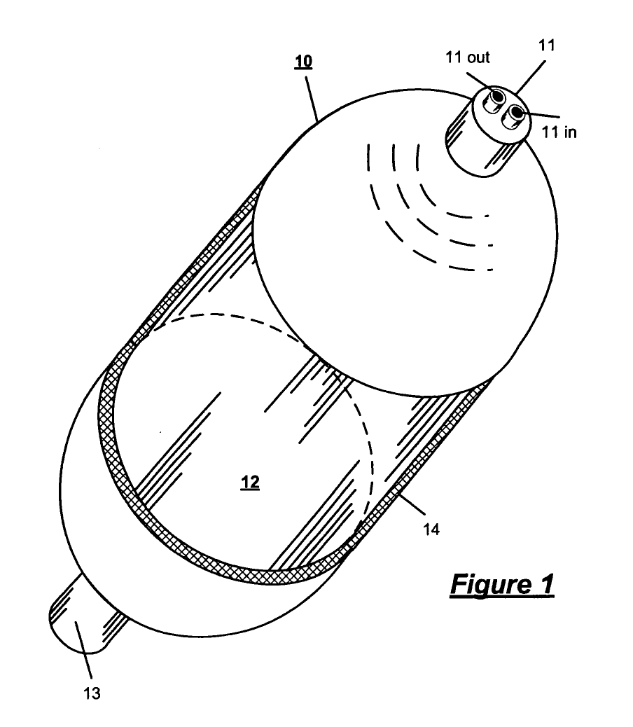

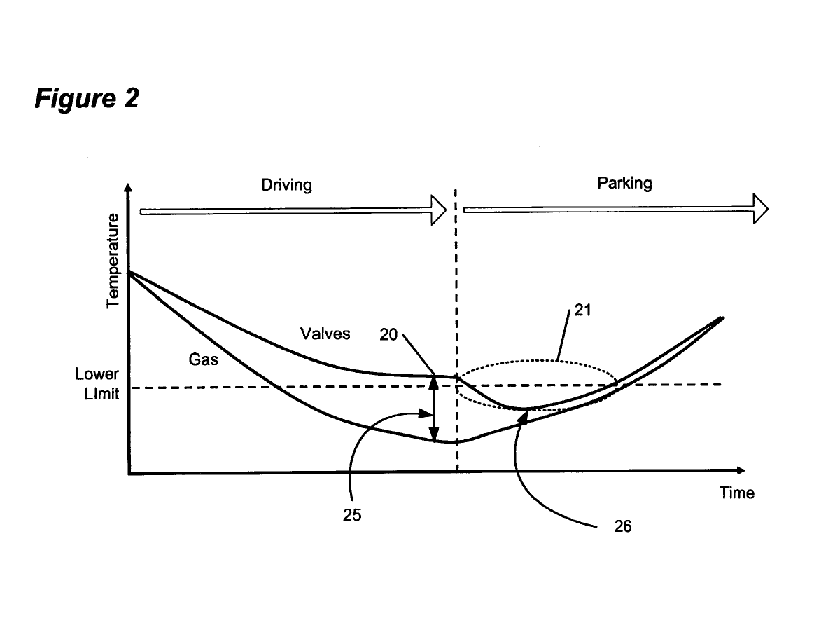

With reference to FIG. 1, high pressure tanks are typically cylindrical with semi spherically shaped domed ends and are formed from a carbon composite shell, a mixture of resin and carbon fiber and may also include supplemental shells such as an outer shell and an interior liner sandwiching a carbon fiber middle layer. FIG. 1 shows a typical high pressure gas storage tank 10 having an interior volume 12 for the storage of gas is shown with sidewall 14, including a first boss 11 and second boss 13 at either end, A gas inlet and gas outlet are shown at boss 11 as 11in and 11out. Driving and parking temperature conditions in the vehicle tank system are charted in FIG. 2. During driving, the gas temperature may exceed the lower tolerance limit by the temperature difference shown as 25. In a typical parking condition, FIG. 2 illustrates that with time, the temperature 20 of the valve system cools to a difference 26 such that, in the period shortly after parking 21, the valve temperature 20 cools below the lower acceptable limit of temperature tolerance.

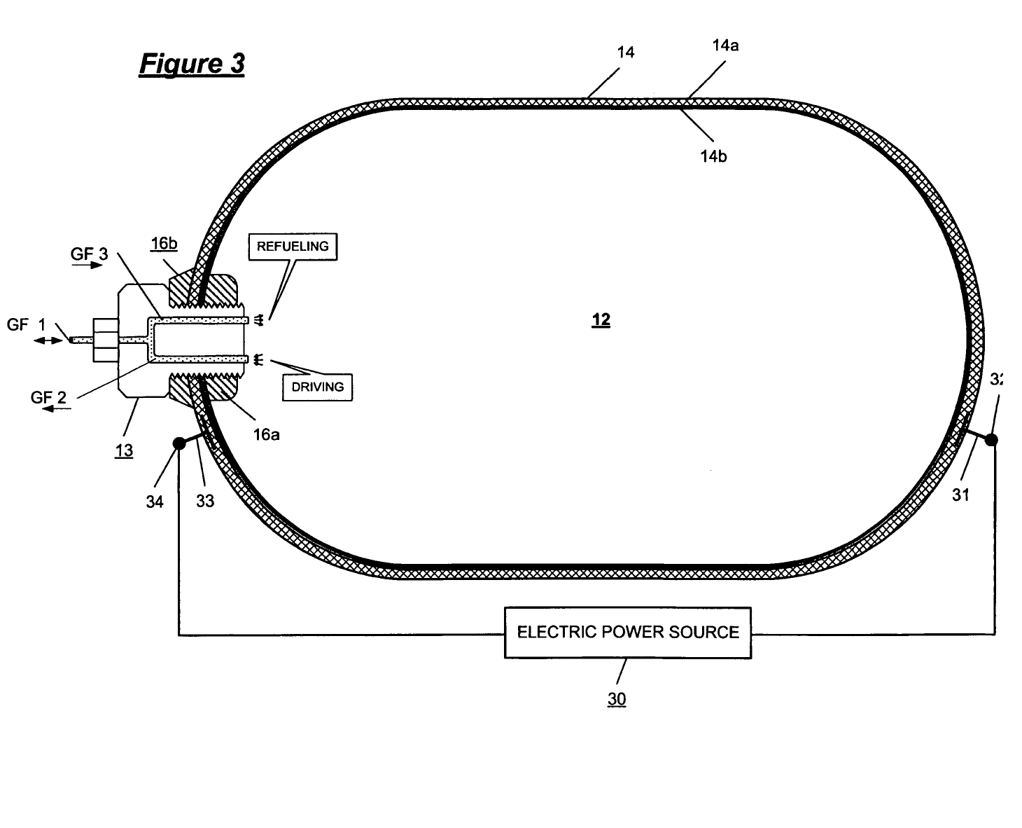

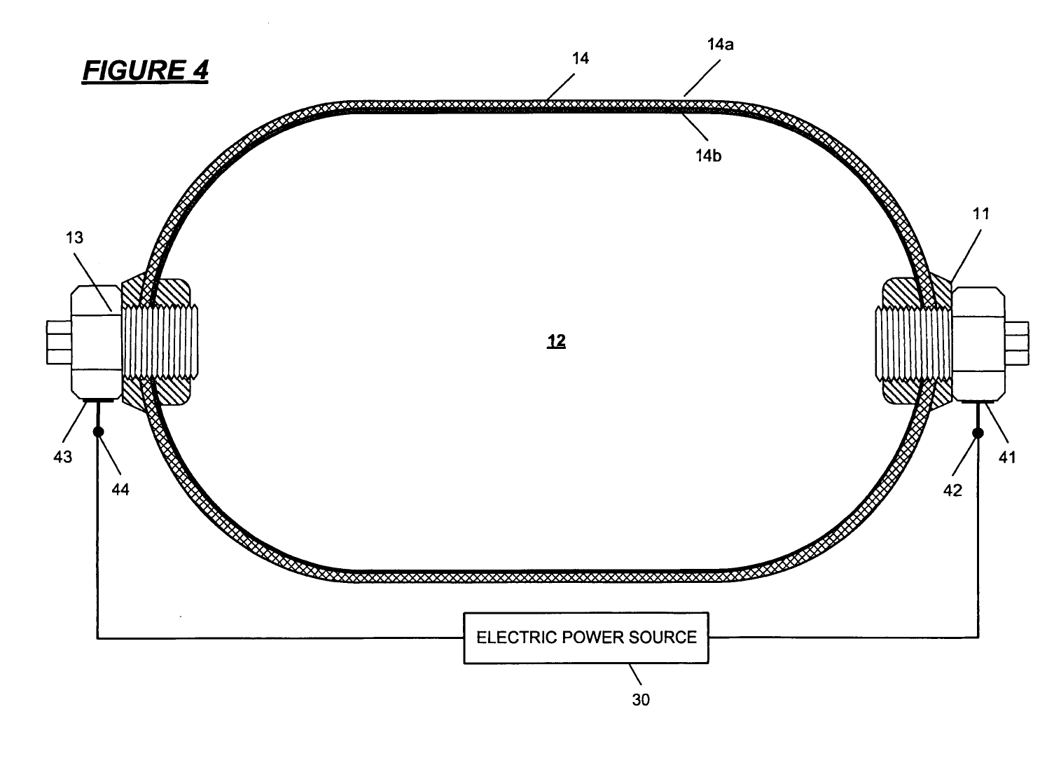

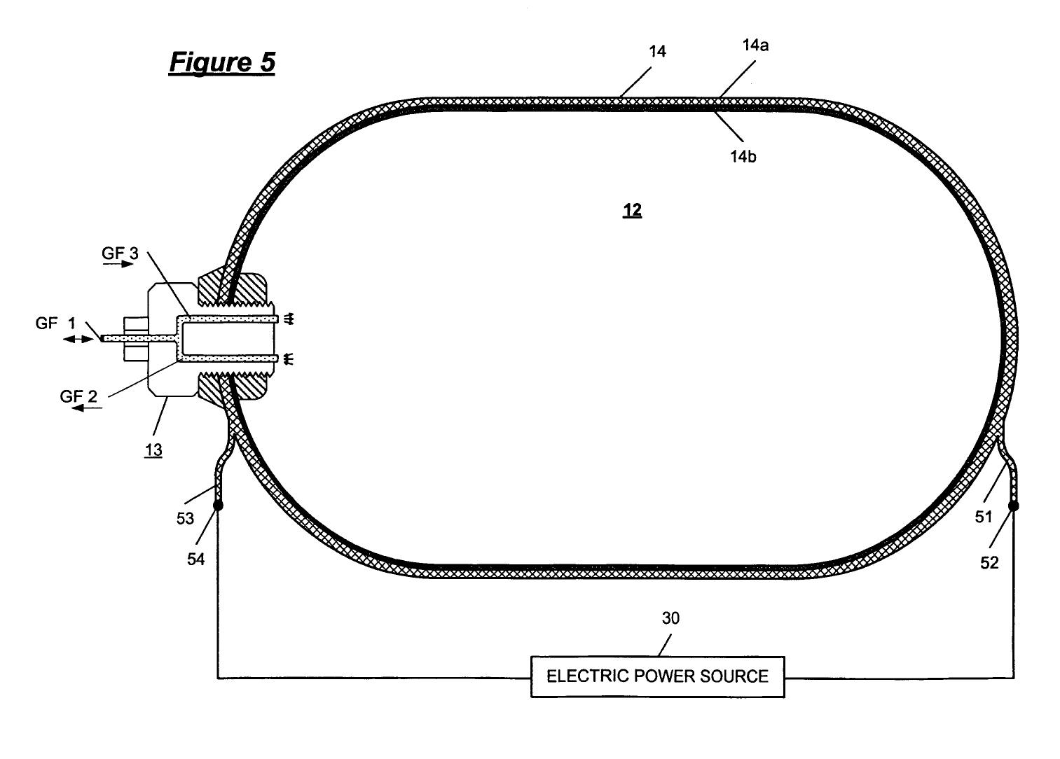

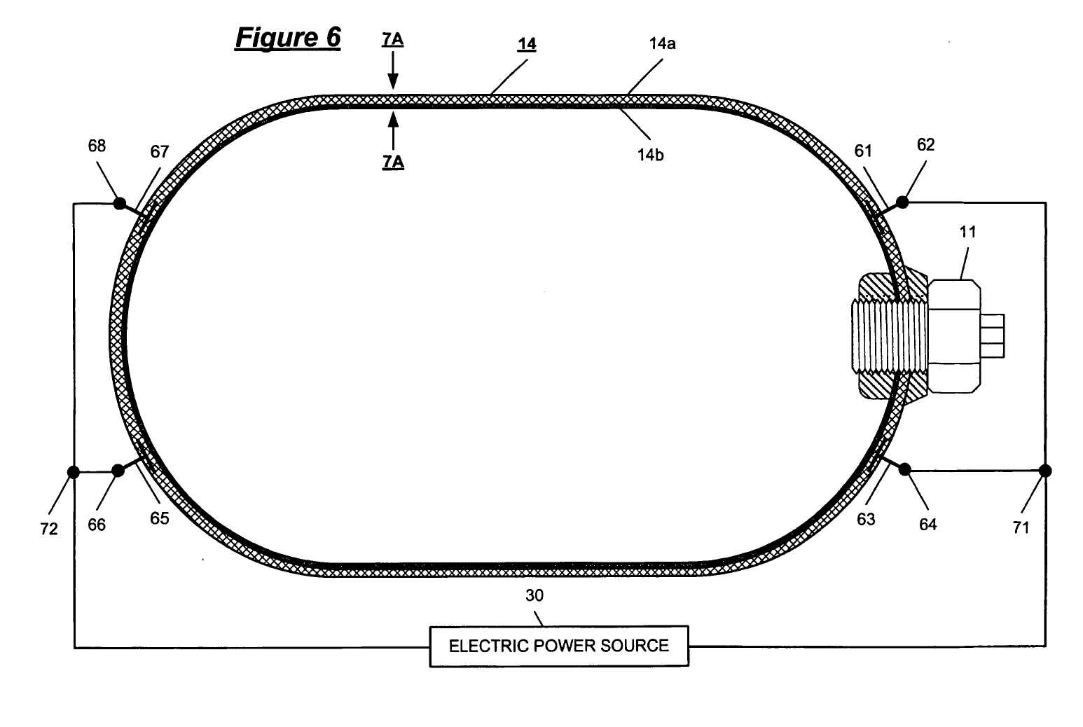

FIG. 3 depicts component parts of an example of a heating system: tank 14, composite shell 14a and liner 14b, interior volume for gas storage 12, boss 13, and gas flow conduits: external inlet/outlet conduit GF 1, internal outlet conduit GF 2 for depletion of gas during driving and internal inlet conduit GF 3 for gas refilling. The gas flow conduits embedded in the boss may also have embedded therein (not shown) check valves, a pressure regulator and control valves in each of GF 2 and GF 3. Electrodes 31 and 33 are embedded in the composite fiber tank wall connecting with conductive/resistive fibers to define an electrically resistive path for current flow within the tank wall for heating the composite shell. The electrodes are connected to terminals 32 and 34 that are in turn connected to an electrical power source 30 providing a flow of warming current to the conductive shell. FIG. 4 is a side view of a warming system of the invention wherein the electric power source 30 is interconnected to the conductive metal bosses 11 and 13 extending from opposite ends at either side of the tank. The boss electrodes 41 and 43 are connected to terminals 42 and 44 that are in turn connected to electrical power source 30 providing a flow of warming current to the conductive shell. FIG. 5 is a side view of a warming system of the invention wherein an electric power source is interconnected to electrically conductive fiber extension elements 51 and 53 intrinsically formed in the tank shell and leading from the conductive composite tank shell 14a at each of the opposite sides of the tank ends. The intrinsic tank electrodes 51 and 53 are connected to terminals 52 and 54 that are in turn connected to electrical power source 30 providing a flow of warming current to the conductive shell. FIG. 6 is a side view of a warming system of the invention wherein electrodes 61, 63, 65, and 67 are implanted within the tank wall at locations predetermined on the tank based on the conductivity properties of the composite material forming the tank. The electrodes are interconnected with an electric power source through terminals 62, 64, 66 and 68 that are in turn connected to electrical power source 30 providing a flow of warming current to the conductive shell.

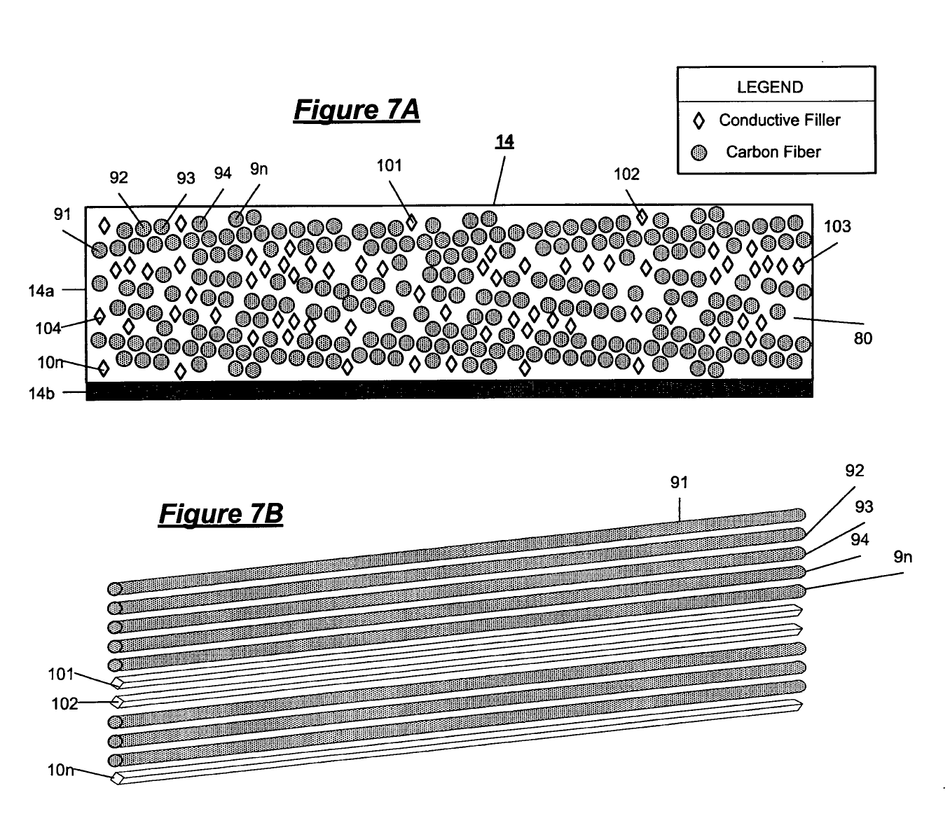

FIG. 7A is an enlarged cross section of typical wall section of a tank having an interior liner such as shown in tank wall segment 7A→ ←7A in FIG. 6. In FIG. 7A, the composite tank shell 14a is shown formed from an epoxy binder 80, having embedded therein longitudinally extending carbon filler fiber material strands 91, 92, 93, 94, 9n, . . . and longitudinally extending conductive filler fiber material strands 101, 102, 103, 104, and 10n, . . . The typically solid plastic liner 14b is shown bonded to the interior surface of composite shell 14a. FIG. 7B shows enlarged cross sections of a tank wall segment showing an alignment of fiber strands depicted in FIG. 7A.

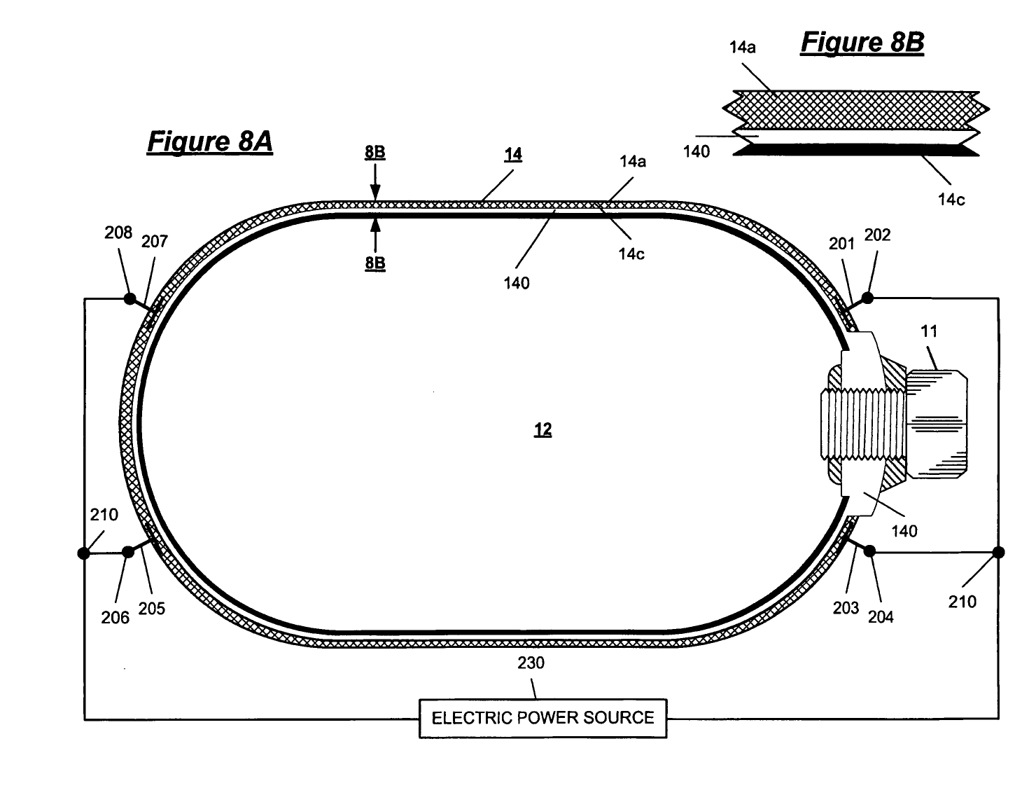

FIG. 8A shows, in a side cross section detail, a tank wall 14 including a conductive/resistive composite structure 14a having an interior metal liner 14c with an insulating layer 140 sandwiched between the conductive composite tank structure 14a and the metal liner 14c. In FIG. 8A, the warming system of the invention includes electrodes 201, 203, 205, and 207 implanted within the tank wall. The electrodes are interconnected with an electric power source through terminals 202, 204, 206 and 208 that are in turn connected to electrical power source 230 providing a flow of warming current to the conductive shell. The insulating layer 140 isolates both the conductive wall of the tank 14a from the electrically conductive tank wall 14a and the metal boss 11 from the flow of electric current to prevent a shorting condition.

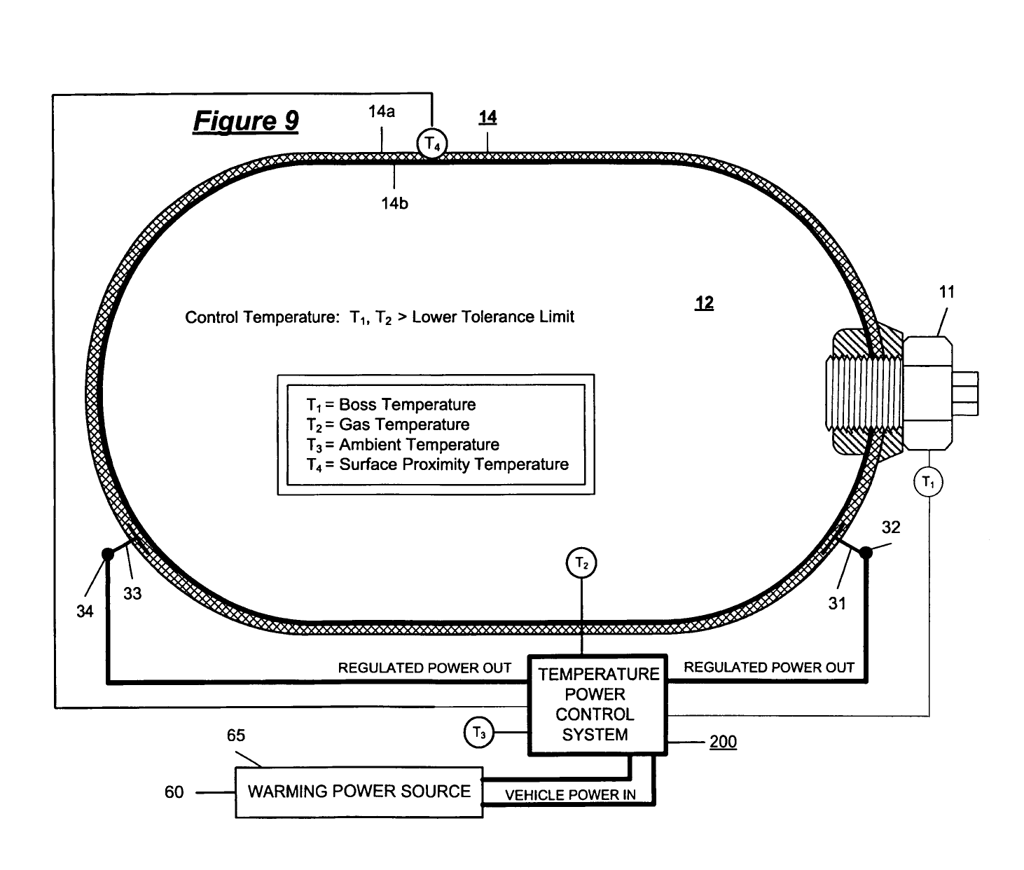

FIG. 9 illustrates a temperature control system utilized in the invention useful with embodiments of the invention. The temperature control system may be utilized for overall temperature monitoring and regulation of the tank and gas flow components. In the example in FIG. 9, sensors measure T₁=Boss Temperature; T₂=Gas Temperature; T₃=Ambient Temperature; and T₄=Surface Proximity Temperature. The sensed temperatures are input into the control system 200 regulating overall gas and tank temperature such that the Control Temperature, generated by the warming system, as regulated by the control processor 200 is: T₁, T₂>Lower Tolerance Limit of the tank and valve components. Control processor 200 regulates the energy flow from the warming power source 65 input into the supplemental warming system, which may be either an electrical system or a fluid system, interconnected to the tank at energy input connectors 61 and 62. With reference to FIG. 2 showing temperatures in various operating modes, the control system 200 will warm the system such that the differentials shown as 25 and 26 are eliminated and the lower tolerance limit of the system is not exceeded.

With reference to FIG. 7A and FIG. 7B, preferred electrically conductive materials used in forming the tank wall include a filler that is usually a powder composition characterized by an average particle size ranging from about approximately ????????? to about approximately ?????????. Useful powders include metal powders such as Al, Cu, Ni, Ag, SUS, Ti, and similar metal compositions having like conductive properties and metal plated carbon black, ceramic, and plastic powders. The tank wall fiber component includes wires formed from the aforementioned metals and metal plated fibers such as carbon fibers, glass fibers, plastic fibers and carbon nano tube fibers. Useful resistive/conductive parameters for the expanse of the tank wall heated as determined by the placement of the electrodes connected to the power source range in resistance from 0.1 ohm to 100 ohm.

In the example of the control system depicted with reference to FIG. 9, the power source (AC or DC, and respective voltage and current and frequency) is a matter of design choice allowing many variations depending on the optimum design control temperature. Power requirements are calculated in accordance with Ohm's law. Warming power input into the system, P-warming [W], is determined by the tank temperature during the vehicle operation, wherein Current (I) is determined by the formula: I-tank=(P-warming/R-tank)̂0.5; Voltage (E) is determined by the formula: EI-tank=I-tank×R-tank. From an electrical isolation point, the tank warming power source may be isolated from other electric lines in the vehicle depending on designer preference. In this case, a DC/DC converter or DC/AC inverter must be installed as the tank warming power source.

Having described the invention in detail, those skilled in the art will appreciate that, given the present description, modifications may be made to the invention without departing from the spirit of the inventive concept herein described. Therefore, it is not intended that the scope of the invention be limited to the specific and preferred embodiments illustrated and described. Rather, it is intended that the scope of the invention be determined by the appended claims.

1: A heating system for a fiber composite high pressure gas storage tank for maintaining the temperature of the gas within the tank and the gas flow components associated with the tank gas flow control system at one or more boss assembly at the tank ends above the lower temperature design tolerance limit for the tank and boss assembly comprising a tank formed from a polymeric binder having embedded therein longitudinally extending electrically conductive and resistive fiber material strands and an electric power source interconnected with the conductive and resistive fibers forming the tank wall, whereby the electrically conductive and resistive fiber material strands in the tank intrinsically heat the tank and boss assembly system upon the application of an electric current.

2: The heating system of claim 1 wherein electrodes are embedded in the composite fiber composition of the tank wall to define an electrically resistive path for current flow within the conductive fiber materials of the tank wall.

3: The heating system of claim 1 wherein conductive metal bosses at either end of the tank are connected to an electrical power source providing a flow of warming current to the conductive shell.

4: The heating system of claim 1 wherein an electric power source is interconnected to electrically conductive fiber extension elements intrinsically formed in the tank shell and lead from the conductive composite tank shell at each of the opposite sides of the tank ends to an interconnection with an electrical power source.

5: The system of claim 3 further including 1) a metal boss at either or both ends of the tank; 2) a tank wall having an interior metal liner; and 3) an insulating layer sandwiched between the conductive fiber composite tank shell structure and the metal liner, wherein the insulating layer isolates the conductive wall of the tank from the electrically conductive fiber wall and the one or more metal boss from the flow of electric current.

6: The system of claim 1 including a temperature control system utilizing temperature sensors to provide temperature measurement data input into the control system for one or more of valve temperature, tank wall temperature, gas temperature and ambient temperature such that the control temperature maintained by the system, as determined by the flow of electric current into the fiber components of the tank is such that the gas temperature and the temperature of the metal components associated with the tank does not drop below the lower tolerance temperature limit of the tank and the components associated with the tank gas flow control system at the one or more boss at the tank ends.

7: The system of claim 2 including a temperature control system utilizing temperature sensors to provide temperature measurement data input into the control system for one or more of valve temperature, tank wall temperature, gas temperature and ambient temperature such that the control temperature maintained by the system, as determined by the flow of electric current into the fiber components of the tank is such that the gas temperature and the temperature of the metal components associated with the tank does not drop below the lower tolerance temperature limit of the tank and the components associated with the tank gas flow control system at the one or more boss at the tank ends.

8: The system of claim 3 including a temperature control system utilizing temperature sensors to provide temperature measurement data input into the control system for one or more of valve temperature, tank wall temperature, gas temperature and ambient temperature such that the control temperature maintained by the system, as determined by the flow of electric current into the fiber components of the tank is such that the gas temperature and the temperature of the metal components associated with the tank does not drop below the lower tolerance temperature limit of the tank and the components associated with the tank gas flow control system at the one or more boss at the tank ends.

9: The system of claim 4 including a temperature control system utilizing temperature sensors to provide temperature measurement data input into the control system for one or more of valve temperature, tank wall temperature, gas temperature and ambient temperature such that the control temperature maintained by the system, as determined by the flow of electric current into the fiber components of the tank is such that the gas temperature and the temperature of the metal components associated with the tank does not drop below the lower tolerance temperature limit of the tank and the components associated with the tank gas flow control system at the one or more boss at the tank ends.

10: The system of claim 6 including a temperature control system utilizing temperature sensors to provide temperature measurement data input into the control system for one or more of valve temperature, tank wall temperature, gas temperature and ambient temperature such that the control temperature maintained by the system, as determined by the flow of electric current into the fiber components of the tank is such that the gas temperature and the temperature of the metal components associated with the tank does not drop below the lower tolerance temperature limit of the tank and the components associated with the tank gas flow control system at the one or more boss at the tank ends.

11: The warming system of claim 1 wherein electrically conductive materials forming the tank wall include a filler comprised of a metal powder composition.

12: The system of claim 13 wherein the powder composition is comprised of one or more of Al, Cu, Ni, Ag, SUS, and Ti.

13: The system of claim 14 wherein the powder composition is comprised of one or more of carbon black powder, ceramic powder, and plastic powder coated with an electrically conductive metal.

14: The warming system of claim 1 wherein the tank wall includes carbon nano tubes embedded therein.

15: The system of claim 1 wherein electrically conductive fiber materials used in forming the tank wall include metal wires and carbon, glass, and plastic fibers coated with metal.

16: The system of claim 1 wherein the resistive/conductive properties of the tank wall to which the electric current is applied range from 0.1 ohm to 100 ohm.

17: The system of claim 1 including an electric power source interconnected with electrodes associated with the tank wall to form an electrically active circuit for current flow and the warming power input into the system, P-warming [W], is determined by the tank and gas flow assembly tolerance temperature during the vehicle operation, wherein:
Current (I) is determined by the formula: I-tank=(P-warming/R-tank)̂0.5;
and
Voltage (E) is determined by the formula: EI-tank=I-tank×R-tank.

18: The system of claim 1 wherein the electric power source interconnected with the tank wall is isolated from other electric lines in the vehicle.

19: The system of claim 1 wherein a DC/DC converter or DC/AC inverter comprises the tank warming power source.
